(19) United States
(12) Patent Application Publication
(10) Pub. No.: US 2010/0056149 A1
(43) Pub. Date: Mar. 4, 2010

(54) Hard handoff dynamic threshold determination

(75) Inventors: John C. Jubin, Richardson, TX (US); Vijayasimman Rajasimman, Garland, TX (US); Nivedan Thadasina, Allen, TX (US)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/459,317

(22) Filed: Jun. 30, 2009

Related U.S. Application Data
(60) Provisional application No. 61/190,751, filed on Sep. 2, 2008.

(51) Int. Cl. H04W 36/00

(52) U.S. Cl. 455/436

(57) ABSTRACT

A system and method for dynamic threshold determination. The system and method of operating a base station. A base station is configured to transmit a first message to a subscriber station. The first message including a first threshold for use in measuring against the serving frequency strength and a second threshold for determining one or more target base stations. The mobile station responds with messages listing zero or more target base stations. Further, the base station is configured to dynamically adjust a value of at least one of the first threshold parameter and second threshold parameter in response to a call event.

### CROSS-REFERENCE TO RELATED APPLICATION(S) AND CLAIM OF PRIORITY

The present application is related to U.S. Provisional Patent No. 61/190,751, filed Sep. 2, 2008, entitled “HARD HANDOFF DYNAMIC THRESHOLD DETERMINATION”. Provisional Patent No. 61/190,751 is assigned to the assignee of the present application and is hereby incorporated by reference into the present application as if fully set forth herein. The present application hereby claims priority under 35 U.S.C. §119(e) to U.S. Provisional Patent No. 61/190,751.

### TECHNICAL FIELD OF THE INVENTION

The present application relates generally to wireless communications networks and, more specifically, to control, by a base station, a hard handoff of a wireless mobile station from the base station to a target base station.

### BACKGROUND OF THE INVENTION

As is well known, when a wireless mobile station moves from a cell that is served by a source base station to a cell that is served by a target base station it becomes necessary to transfer or “handoff” the wireless mobile station from the source base station to the target base station. In most wireless networks approximately forty percent (40%) to fifty percent (50%) of all active calls experience some type of handoff. These handoffs involve adding cells or dropping cells to an active call, or handing the call over to another cell under the control of another base station. In either case a decision must be made prior to the handoff identifying which cell or cells are to be involved in the handoff and when the handoff is to be performed. If handoffs are not timed properly, needless call drops may occur either before or after the handoff is attempted.

In 3GPP2 (CDMA2000) systems, one of the necessary conditions for inter-frequency hard handoff (handoff to a different CDMA channel while a call is in progress) by a Mobile Station (MS) from one Base Station (BS—the source BS) to another BS (a target BS) is controlled by the threshold parameter CF_T_ADD. A target BS pilot strength must be higher than CF_T_ADD for the Candidate Frequency Search preceding a handoff to be successful. In current implementations, CF_T_ADD is a manually configured parameter. Similar threshold parameters for the source/serving BS/frequency and for intra-frequency hard handoff are also manually configured.

### SUMMARY OF THE INVENTION

A method of operating a base station is provided. The method includes transmitting a first message to a mobile station. The first message includes a first threshold for use in measuring against the serving frequency strength and a second threshold for determining one or more target base stations. The mobile station responds with messages listing zero or more target base stations. A value of at least one of the first threshold parameter and second threshold parameter is dynamically adjusted in response to whether the thresholds were met before the call was dropped or whether or not an acknowledgement to the Handoff Direction Message was received.

A wireless communication network is provided. The wireless communication network includes a plurality of base stations. At least one of the plurality of base stations includes a handoff controller. The handoff controller is configured to cause the base station to transmit a first message to a mobile station. The first message includes a first threshold for use in measuring against the serving frequency strength and a second threshold for determining one or more target base stations. The mobile station responds with messages listing zero or more target base stations. Further, the handoff controller is configured to dynamically adjust a value of at least one of the first threshold parameter and second threshold parameter in response to whether the thresholds were met before the call was dropped or whether or not an acknowledgement to the Handoff Direction Message was received.

A base station is provided. The base station includes a base station controller, a transceiver, and a handoff controller. The handoff controller is configured to cause the base station to transmit a first message to a mobile station. The first message including a first threshold for determining one or more target base stations and a second threshold for use in measuring against the serving frequency strength. The mobile station responds with messages listing zero or more target base stations. Further, the handoff controller is configured to dynamically adjust a value of at least one of the first threshold parameter and second threshold parameter in response to whether the thresholds were met before the call was dropped or whether or not an acknowledgement to the Handoff Direction Message was received.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary wireless network according to embodiments of the present disclosure;

FIG. 2A illustrates an exemplary base according to embodiments of the present disclosure;

FIG. 2B illustrates an exemplary femto base according to embodiments of the present disclosure;

FIG. 3 illustrates an exemplary wireless mobile station;

FIG. 4 illustrates a process for performing an inter-frequency hard handoff;

FIG. 5A illustrates a state diagram for dynamically adjusting the handoff thresholds in an inter-frequency hard handoff according to embodiments of the present disclosure;

FIG. 5B illustrates exemplary dynamic handoff threshold parameter adjustments according to embodiments of the present disclosure;

FIG. 6A illustrates a process for performing an intra-frequency hard handoff; and

FIG. 6B illustrates a state diagram for dynamically adjusting the handoff thresholds in an intra-frequency hard handoff according to embodiments of the present disclosure.

### DETAILED DESCRIPTION OF THE INVENTION

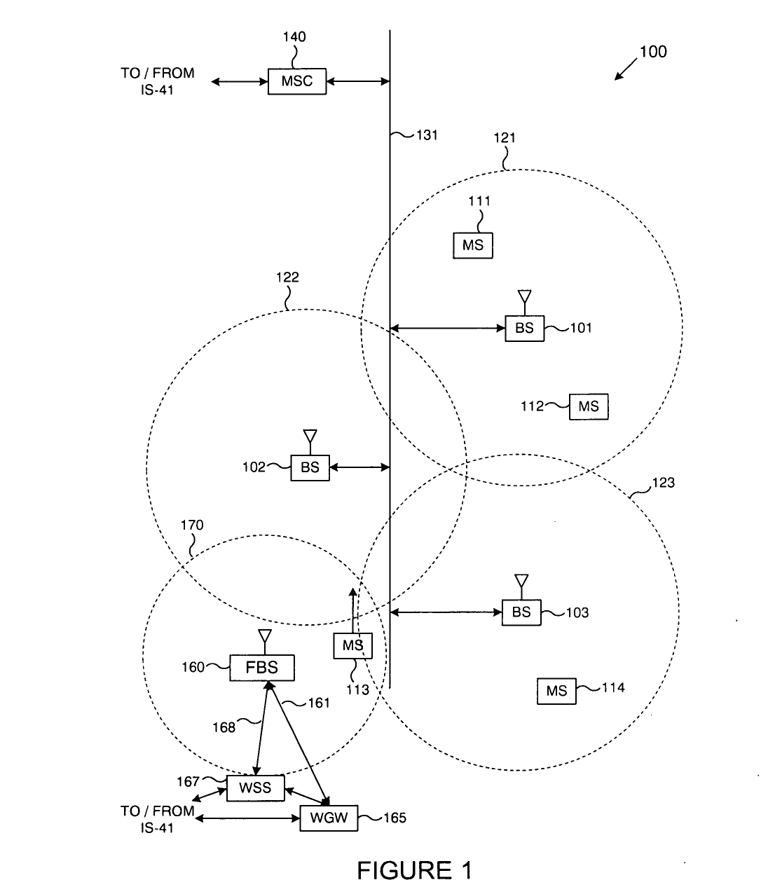

FIGS. 1 through 6B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless network.

It will be understood that examples wherein the serving base station is a femto base station (e.g., FBS 160) is for illustration and example only. Embodiments wherein the serving base station is a macro base station (such as BS 101, BS 102 and BS 103) could be used without departing from the scope of this disclosure. Embodiments of the present disclosure illustrate adjustments to one or more parameters (e.g., SF_TOTAL_Ec/Io, CF_T_ADD, T_DROP, and T_ADD discussed herein below) in response to a call event (i.e., a call drops, the Handoff Direction Message is acknowledged, or the Handoff Direction Message is not acknowledged; alternatively, a number of calls in a row drop, a number of Handoff Direction Messages in a row get acknowledged, or a number of Handoff Direction Messages in a row do not get acknowledged).

FIG. 1 illustrates exemplary wireless network 100 according to embodiments of the present disclosure. The embodiment of wireless network 100 illustrated in FIG. 1 is for illustration only. Other embodiments of the wireless network 100 could be used without departing from the scope of this disclosure.

Wireless network 100 comprises a plurality of cells 121-123, each containing one of the base stations, BS 101, BS 102, or BS 103. Base stations 101-103 communicate with a plurality of mobile stations (MS) 111-114 over code division multiple access (CDMA) channels). Mobile stations 111-114 may be any suitable wireless devices (e.g., conventional cell phones, PCS handsets, personal digital assistant (PDA) handsets, portable computers, telemetry devices) that are capable of communicating with base stations 101-103 via wireless links.

Dotted lines show the approximate boundaries of cells 121-123 in which base stations 101-103 are located. The cells are shown approximately circular for the purposes of illustration and explanation only. It should be clearly understood that the cells may have other irregular shapes, depending on the cell configuration selected and natural and man-made obstructions.

As is well known in the art, each of cells 121-123 is comprised of a plurality of sectors, where a directional antenna coupled to the base station illuminates each sector. The embodiment of FIG. 1 illustrates the base station in the center of the cell. Alternate embodiments may position the directional antennas in corners of the sectors. The system of the present disclosure is not limited to any particular cell configuration.

In some embodiments, each of BS 101, BS 102 and BS 103 comprises a base station controller (BSC) and one or more base transceiver subsystem(s) (BTS). Base station controllers and base transceiver subsystems are well known to those skilled in the art. A base station controller is a device that manages wireless communications resources, including the base transceiver subsystems, for specified cells within a wireless communications network. A base transceiver subsystem comprises the RF transceivers, antennas, and other electrical equipment located in each cell site. This equipment may include air conditioning units, heating units, electrical supplies, telephone line interfaces and RF transmitters and RF receivers. For the purpose of simplicity and clarity in explaining the operation of the present disclosure, the base transceiver subsystems in each of cells 121, 122 and 123 and the base station controller associated with each base transceiver subsystem are collectively represented by BS 101, BS 102 and BS 103, respectively.

BS 101, BS 102 and BS 103 transfer voice and data signals between each other and the public switched telephone network (PSTN) (not shown), or any IS-41 communication network as is known in the art, via communication line 131 and mobile switching center (MSC) 140. Line 131 also provides the connection path for control signals transmitted between MSC 140 and BS 101, BS 102 and BS 103 that establish connections for voice and data circuits between MSC 140 and BS 101, BS 102 and BS 103.

Communication line 131 may be any suitable connection means, including a T1 line, a T3 line, a fiber optic link, a network packet data backbone connection, or any other type of data connection. Line 131 links each vocoder in the BSC with switch elements in MSC 140. The connections on line 131 may transmit analog voice signals or digital voice signals in pulse code modulated (PCM) format, Internet Protocol (IP) format, asynchronous transfer mode (ATM) format, or the like.

MSC 140 is a switching device that provides services and coordination between the subscribers in a wireless network and external networks, such as the IS-41, PSTN, or Internet. MSC 140 is well known to those skilled in the art. In some embodiments of the present disclosure, communications line 131 may be several different data links where each data link couples one of BS 101, BS 102, or BS 103 to MSC 140.

In some embodiments, the wireless network 100 includes a Femto-cell base station (FBS) 160. FBS 160 includes components analogous to those found in macro base stations BS 101, BS 102 and BS 103. As such, FBS 160 comprises a femto base station controller (FBSC) and one or more femto base transceiver subsystem(s) (FBTS). FBS 160 communicates with mobile stations in its served area using IS-95, CDMA or any other cellular communications standard.

Voice bearer traffic is transferred between the FBS 160 and the IS-41 network (e.g., PSTN) via communication line 161, Wireless Gateway (WGW) 165. Signaling/control traffic are transferred between the FBS 160 and the IS-41 network via communication line 168 and Wireless Soft Switch (WSS) 167. The WGW 165 and WSS 167 are coupled via a backhaul connection (not shown), e.g., the IS-41, to the MSC 140. The WGW 165 provides a bearer path between FBS 160 and MSC 140 via the IS-41. The WSS 167 provides a signaling path FBS 160 and WGW 165 as well as to the MSC 140 via the IS-41.

A dotted line shows the approximate boundary of cell 170 in which FBS 160 is located. The cell is shown approximately circular for the purposes of illustration and explanation only. It should be clearly understood that the cell may have an irregular shape, depending on the cell configuration selected and natural and man-made obstructions.

In the example wireless network 100, MS 111 is located in cell 121 and is in communication with BS 101. MS 113 is located in cell 170, is in communication with FBS 160 and is moving in the direction of cell 122, as indicated by the direction arrow proximate MS 113. At some point, as MS 113 moves into cell 122 and out of cell 170, a hand-off will occur.

The hand-off procedure transfers control of a call from a first cell to a second cell. Embodiments of the present disclosure illustrate a “hard handoff.” In a “hard handoff” the existing connection between the mobile station and the base station in the first cell is broken before a new connection is made between the mobile station and the base station in the second cell.

For example, in an inter-frequency handoff, as MS 113 moves from cell 170 to cell 122, MS 113 conducts a candidate frequency search (CFS) on a frequency different from the serving base station's frequency. After the candidate target base stations are identified, a report of the target base stations is reported by MS 113 to FBS 160. FBS 160 then initiates a handoff process by signaling the target BS 102 that a handoff is required by sending a communication via the WSS 167 to the MSC 140 to BS 102. FBS 160 then signals MS 113 that a handoff is required. MS 113 responds by transmitting an acknowledgment (e.g., layer 2 Ack) to FBS 160.

In prior art systems and embodiments of this disclosure, the handoff process is dependent on the pilot strength measurement. Handoffs may fail because the handoff occurs too early or too late. Embodiments of this disclosure illustrate dynamically adjusting the thresholds that determine when a handoff occurs, therefore improving the chance for a successful handoff.

According to the principles of the standard, the mobile stations operating in wireless network 100 are capable of performing candidate base station searches. The mobile stations 111, 112, 113 and 114 are operable to perform a Candidate Frequency Search (CFS) by reporting the pilot strength (PS) received from multiple base stations.

A CFS is a process by which the mobile station searches for pilot channels on a frequency other the serving frequency. A CFS is performed to assist the base station in determining if handing off to a different frequency is necessary. Thus, CFS searches apply to hard handoffs. The CFS measures received signal strengths of pilots. When the mobile station detects a pilot channel of significant strength, the mobile station reports the pilot channel to a base station controller. The base station controller initiates a handoff procedure to switch the mobile station to a target base station (the base station associated with the pilot channel).

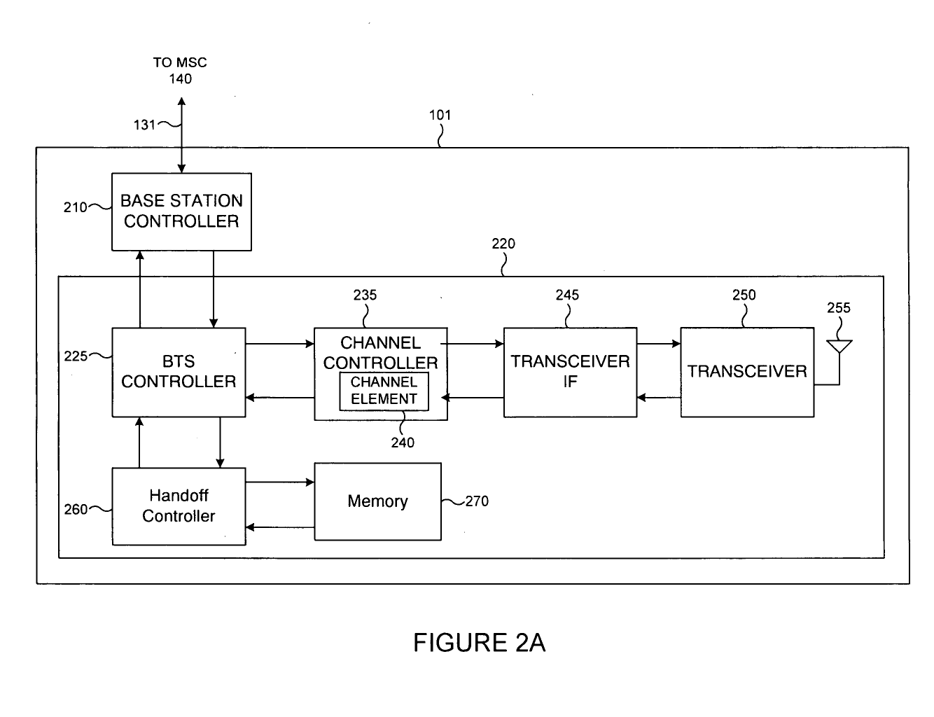

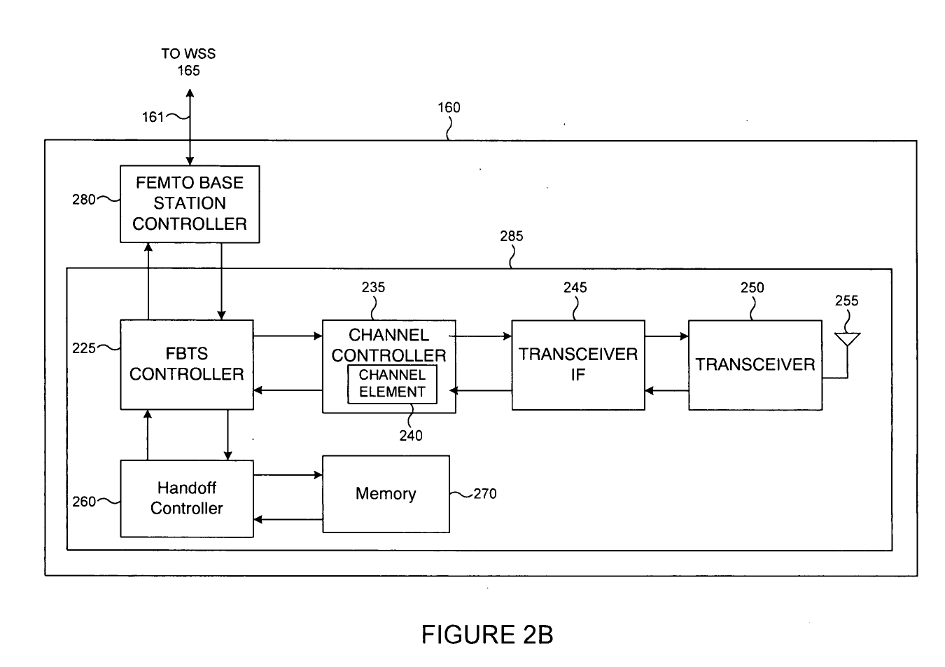

FIG. 2A illustrates exemplary base station 101 in greater detail according to one embodiment of the present disclosure. The embodiment of base station 101 illustrated in FIG. 2A is for illustration only. Other embodiments of the base station 101 could be used without departing from the scope of this disclosure.

Base station 101 comprises base station controller (BSC) 210 and base transceiver subsystem (BTS) 220. Base station controllers and base transceiver subsystems were described previously in connection with FIG. 1. BSC 210 manages the resources in cell site 121, including BTS 220. BTS 220 comprises BTS controller 225, channel controller 235, transceiver interface (IF) 245, RF transceiver unit 250, and antenna array 255. Channel controller 235 comprises a plurality of channel elements, including exemplary channel element 240. BTS 220 also comprises a handoff controller 260. The embodiment of handoff controller 260 and memory 270 included within BTS 220 is for illustration only. Handoff controller 260 and memory 270 can be located in other portions of BS 101 without departing from the scope of this disclosure.

BTS controller 225 comprises processing circuitry and memory capable of executing an operating program that communicates with BSC 210 and controls the overall operation of BTS 220. Under normal conditions, BTS controller 225 directs the operation of channel controller 235, which contains a number of channel elements, including channel element 240, that perform bi-directional communications in the forward channels and the reverse channels. A forward channel refers to a channel in which signals are transmitted from the base station to the mobile station. A reverse channel refers to a channel in which signals are transmitted from the mobile station to the base station. In an advantageous embodiment of the present disclosure, the channel elements communicate according to a code division multiple access (CDMA) protocol with the mobile stations in cell 121. Transceiver IF 245 transfers the bi-directional channel signals between channel controller 240 and RF transceiver unit 250.

Antenna array 255 transmits forward channel signals received from RF transceiver unit 250 to mobile stations in the coverage area of BS 101. Antenna array 255 also sends to transceiver 250 reverse channel signals received from mobile stations in the coverage area of BS 101. In a preferred embodiment of the present disclosure, antenna array 255 is a multi-sector antenna, such as a three-sector antenna in which each antenna sector is responsible for transmitting and receiving in a 120° (degrees) arc of coverage area. Additionally, RF transceiver 250 may contain an antenna selection unit to select among different antennas in antenna array 255 during transmit and receive operations.

According to some embodiments of the present disclosure, handoff controller 260 is configured to dynamically adjust a threshold parameter used in inter-frequency (i.e., different frequency) hard handoffs. Handoff controller 260 also is configured to dynamically adjust the threshold parameter used in intra-frequency (i.e., same frequency) hard handoffs. Handoff controller 260 is operable to store the threshold parameters in a memory 270. Memory 270 can be any computer readable medium, for example, the memory 270 can be any electronic, magnetic, electromagnetic, optical, electro-optical, electro-mechanical, and/or other physical device that can contain, store, communicate, propagate, or transmit a computer program, software, firmware, or data for use by the microprocessor or other computer-related system or method. Memory 270 comprises a random access memory (RAM) and another part of-memory 270 comprises a Flash memory, which acts as a read-only memory (ROM).

According to the principles of the present disclosure, base station 101 may vary a capability of a mobile station (e.g., MS 111) to determine (e.g., identify) the candidate target base stations (e.g., base stations to which a mobile station can be handed-off) to identify candidate target base stations with higher pilot strengths later or with lower pilot strengths earlier (CF_T_ADD). BS 101 also varies a capability of MS 113 to start the candidate search sooner or later (SF_TOTAL_EC_IO_THRESHOLD). In the event that a call drops prior to the identification of a candidate target base station, the base station 101 is configured to lower the CF_T_ADD threshold parameter to improve the success of future candidate searches by MS 111.

Accordingly, BS 101 is configured to continually adjust one or more threshold parameters, such as Serving Frequency Total Energy per Chip (SF_TOTAL_EC_THRESHOLD), Serving Frequency Total Energy per Chip Interference Density (SF_TOTAL_EC_IO_THRESHOLD), Candidate Frequency Threshold Add (CF_T_ADD), Threshold drop (T_DROP) and Threshold Add (T_ADD). FBS 160 adjusts the thresholds to assist towards the success of a hard handoff operation. FBS 160 adjusts one or more threshold parameters to decrease the risk of a call drop prior to hard handoff. Additionally, the FBS 160 assists towards increasing the duration that MS 113 is served by FBS 160. As such, FBS 160 may increase a threshold that causes MS 113 to continue being served by FBS 160 for a longer duration. Additionally, FBS 160 may lower a threshold that postpones MS 113 in finding a target base station.

FIG. 2B illustrates exemplary femto base station 160 in greater detail according to one embodiment of the present disclosure. The embodiment of femto base station 160 illustrated in FIG. 2B is for illustration only. Other embodiments of the femto base station 160 could be used without departing from the scope of this disclosure.

Femto base station 160 comprises femto base station controller (FBSC) 280 and femto base transceiver subsystem (FBTS) 285. Femto base station controllers and femto base transceiver subsystems were described previously in connection with FIG. 1. FBTS 285 also comprises a handoff controller 260. The embodiment of handoff controller 260 and memory 270 included within FBTS 285 is for illustration only. Handoff controller 260 and memory 270 can be located in other portions of FBS 160 without departing from the scope of this disclosure.

FBSC 280 comprises processing circuitry and memory capable of executing an operating program that controls the overall operation of FBTS 285. Under normal conditions, FBSC 280 directs the operation of channel controller 235, which contains a number of channel elements, including channel element 240, that perform bi-directional communications in the forward channels and the reverse channels. A forward channel refers to a channel in which signals are transmitted from the base station to the mobile station. A reverse channel refers to a channel in which signals are transmitted from the mobile station to the base station. Transceiver IF 245 transfers the bi-directional channel signals between channel controller 240 and RF transceiver unit 250.

Antenna array 255 transmits forward channel signals received from RF transceiver unit 250 to mobile stations in the coverage area of FBS 160. Antenna array 255 also sends to transceiver 250 reverse channel signals received from mobile stations in the coverage area of FBS 160.

According to embodiments of the present disclosure, handoff controller 260 is configured to dynamically adjust a threshold parameter used in inter-frequency (i.e., different frequency) hard handoffs. Handoff controller 260 also is configured to dynamically adjust the threshold parameter used in intra-frequency (i.e., same frequency) hard handoffs. Handoff controller 260 is operable to store the threshold parameters and in a memory 270. Memory 270 can be any computer readable medium, for example, the memory 270 can be any electronic, magnetic, electromagnetic, optical, electro-optical, electro-mechanical, and/or other physical device that can contain, store, communicate, propagate, or transmit a computer program, software, firmware, or data for use by the microprocessor or other computer-related system or method. Memory 270 comprises a random access memory (RAM) and another part of memory 270 comprises a Flash memory, which acts as a read-only memory (ROM).

According to the principles of the present disclosure, FBS 160 may vary a capability of MS 113 to determine (e.g., identify) the candidate target base stations (e.g., base stations to which a mobile station can be handed-off) to identify candidate target base stations with higher pilot strengths later or with lower pilot strengths earlier (CF_T_ADD_). FBS 160 also varies a capability of MS 113 to start the candidate search sooner or later (SF_TOTAL_EC_IO_THRESHOLD). In the event a call drops prior to the identification of a candidate target base station, the femto base station 160 is configured to lower the CF_T_ADD threshold parameter to improve the success of future candidate searches by MS 113.

Accordingly, FBS 160 is configured to continually adjust one or more threshold parameters, such as SF_TOTAL_EC_THRESHOLD, SF_TOTAL_EC_IO_THRESHOLD, CF_T_ADD, T_DROP and T_ADD. FBS 160 adjusts the thresholds to assist towards the success of a hard handoff operation. FBS 160 adjusts one or more threshold parameters to decrease the risk of a call drop prior to hard handoff. Additionally, the FBS 160 assists towards increasing the duration that MS 113 is served by FBS 160. As such, FBS 160 may increase a threshold that causes MS 113 to continue being served by FBS 160 for a longer duration. Additionally, FBS 160 may lower a threshold that postpones MS 113 in finding a target base station.

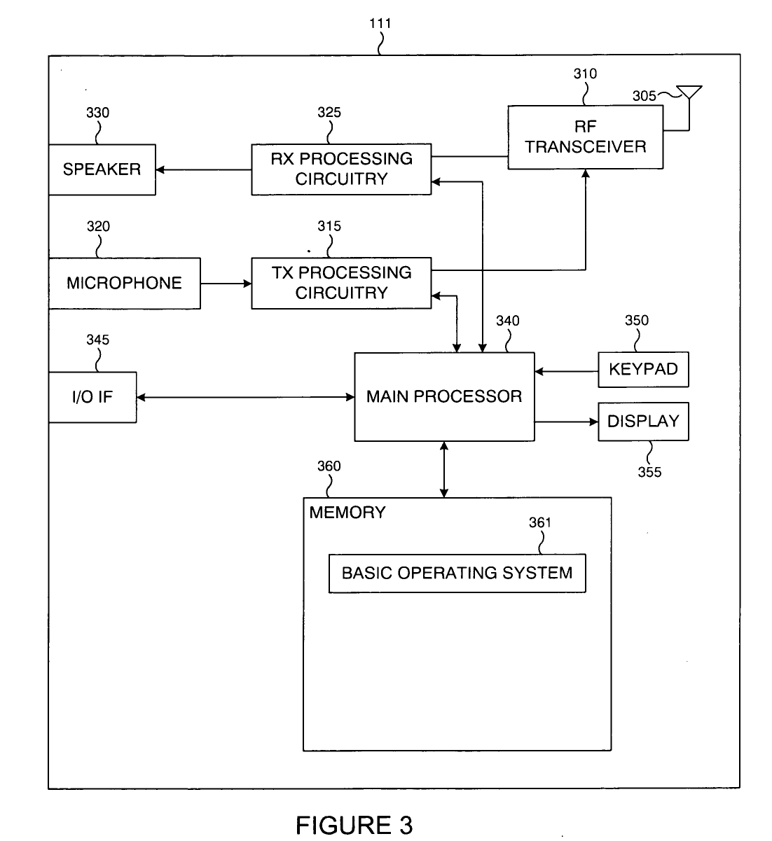

FIG. 3 illustrates wireless mobile station 111. The embodiment of wireless mobile station 111 illustrated in FIG. 3 is for illustration only. Other embodiments of the wireless mobile station 111 could be used without departing from the scope of this disclosure.

Wireless mobile station 111 comprises antenna 305, radio frequency (RF) transceiver 310, transmit (TX) processing circuitry 315, microphone 320, and receive (RX) processing circuitry 325. MS 111 also comprises speaker 330, main processor 340, input/output (I/O) interface (IF) 345, keypad 350, display 355, and memory 360. Memory 360 further comprises basic operating system (OS) program 361.

Radio frequency (RF) transceiver 310 receives from antenna 305 an incoming RF signal transmitted by a base station of wireless network 100. Radio frequency (RF) transceiver 310 down-converts the incoming RF signal to produce an intermediate frequency (IF) or a baseband signal. The IF or baseband signal is sent to receiver (RX) processing circuitry 325 that produces a processed baseband signal by filtering, decoding, and/or digitizing the baseband or IF signal. Receiver (RX) processing circuitry 325 transmits the processed baseband signal to speaker 330 (i.e., voice data) or to main processor 340 for further processing (e.g., web browsing).

Transmitter (TX) processing circuitry 315 receives analog or digital voice data from microphone 320 or other outgoing baseband data (e.g., web data, e-mail, interactive video game data) from main processor 340. Transmitter (TX) processing circuitry 315 encodes, multiplexes, and/or digitizes the outgoing baseband data to produce a processed baseband or IF signal. Radio frequency (RF) transceiver 310 receives the outgoing processed baseband or IF signal from transmitter (TX) processing circuitry 315. Radio frequency (RF) transceiver 310 up-converts the baseband or IF signal to a radio frequency (RF) signal that is transmitted via antenna 305.

In some embodiments of the present disclosure, main processor 340 is a microprocessor or microcontroller. Memory 360 is coupled to main processor 340. According to an advantageous embodiment of the present disclosure, part of memory 360 comprises a random access memory (RAM) and another part of memory 360 comprises a Flash memory, which acts as a read-only memory (ROM).

Main processor 340 executes basic operating system (OS) program 361 stored in memory 360 in order to control the overall operation of wireless mobile station 111. In one such operation, main processor 340 controls the reception of forward channel signals and the transmission of reverse channel signals by radio frequency (RF) transceiver 310, receiver (RX) processing circuitry 325, and transmitter (TX) processing circuitry 315, in accordance with well-known principles.

Main processor 340 is capable of executing other processes and programs resident in memory 360. Main processor 340 can move data into or out of memory 360, as required by an executing process. Main processor 340 is also coupled to I/O interface 345. I/O interface 345 provides mobile station 111 with the ability to connect to other devices such as laptop computers and handheld computers. I/O interface 345 is the communication path between these accessories and main controller 340.

Main processor 340 is also coupled to keypad 350 and display unit 355. The operator of mobile station 111 uses keypad 350 to enter data into mobile station 111. Display 355 may be a liquid crystal display capable of rendering text and/or at least limited graphics from web sites. Alternate embodiments may use other types of displays.

Main processor 340 is configured to utilize thresholds received from FBS 160 to assist in performing a hard handoff. Main processor 160 is configured to execute a plurality of instructions in memory 360 to determine when conditions are such that a handoff should be or can be performed.

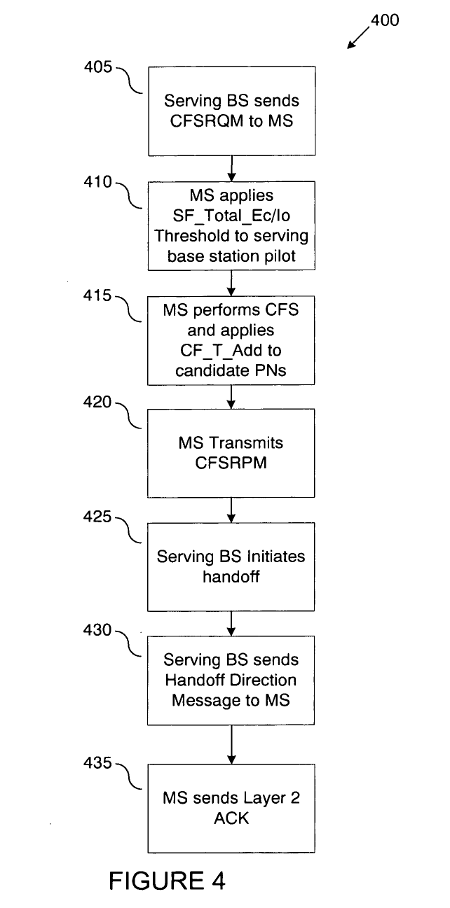

FIG. 4 illustrates a process for performing an inter-frequency hard handoff according to embodiments of the present disclosure. The embodiment of hard handoff process 400 shown in FIG. 4 is for illustration only. Other embodiments of the hard handoff process 400 could be used without departing from the scope of this disclosure.

In step 405, MS 113, engaged in a call, receives a CFS Request Message (CFSRQM) from FBS 160. The CFSRQM includes data such as, but not limited to, the candidate frequency to be searched, one or more threshold parameters (i.e., SF_TOTAL_EC_THRESHOLD and/or SF_TOTAL_EC_IO_THRESHOLD (hereinafter “SF_TOTAL_Ec/Io”) and CF_T_ADD), and candidate Neighbor Pseudo Noise (PNs) sequence offset Indexes (IDs) for target base stations.

In step 410, MS 113 applies SF_TOTAL_Ec/Io to the pilot signal for FBS 160 (i.e., the serving BS). The pilot signal has a corresponding strength (i.e., pilot signal strength) as received by the MS 113. MS 113 compares the pilot signal strength from FBS 160 against SF_TOTAL_Ec/Io. In the event that the pilot signal strength for FBS 160 falls below SF_TOTAL_Ec/Io, MS 113 performs a CFS in step 415.

In step 415, MS 113 measures pilot signals from one or more of the PNs for the candidate frequency. Further, MS 113 compares the pilot signal strengths of the target base stations against a candidate frequency target threshold parameter (e.g., CF_T_ADD) in step 415.

MS 113 transmits the pilot signal strengths to FBS 160 in Candidate Frequency Search Report Message (CFSRPM) in step 420. MS 113 generates the CFSRPM by including all the PNs whose pilot signal is greater than (>) the CF_T_ADD. In some examples, the CFSRPM includes no PNs whose signal is greater than CF_T_ADD. MS 113 periodically conducts the CFS and generates and transmits the resulting CFSRPM. For example, MS 113 can conduct a CFS and transmit a new CFSRPM created therefrom every half second.

When FBS 160 receives the CFSRPM that indicates that both threshold parameters have been met (e.g., contains PNs whose pilot signal is greater than CF_T_ADD from CFS conducted in response to serving signal <SF_TOTAL_Ec/Io), FBS 160 (e.g., the serving base station) initiates a hard handoff procedure in step 425. FBS 160 sends a message via the WSS 167 and the MSC 140 (e.g., via IS-41 connection discussed herein above) to BS 102 (e.g., one of the target PNs identified in the CFSRPM whose signal is greater than CF_T_ADD).

In step 430, FBS 160 also sends a Handoff Direction Message (HDM) to MS 113. The HDM includes a frequency and PN (i.e., a base station identifier) for BS 102.

In response, MS 113 transmits a layer two (2) Acknowledgement (Ack) to FBS 160 in step 435.

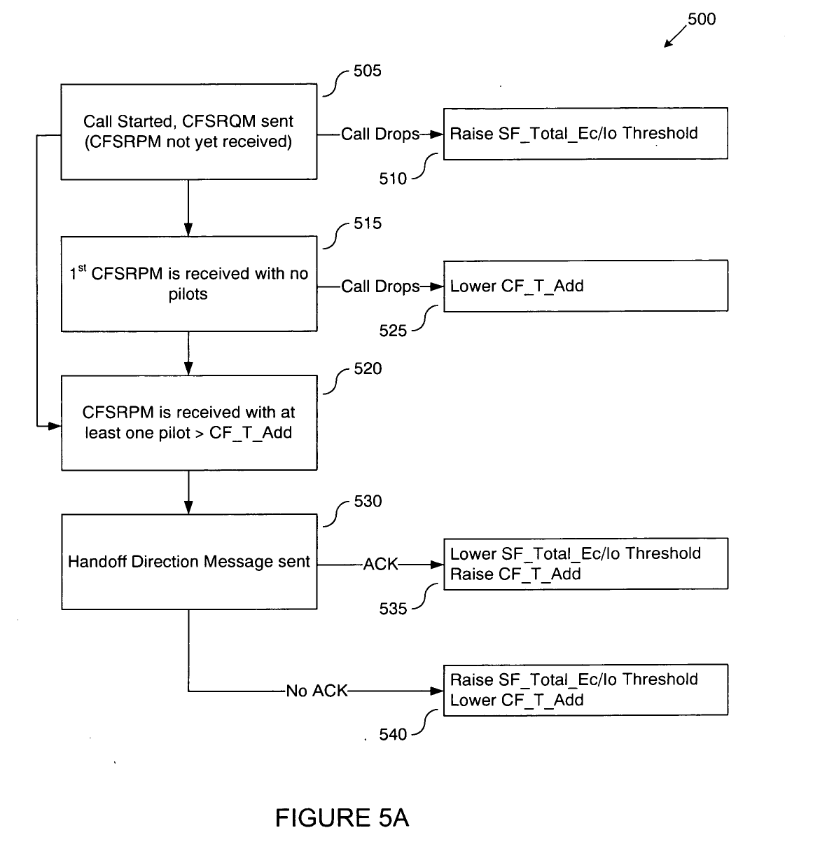

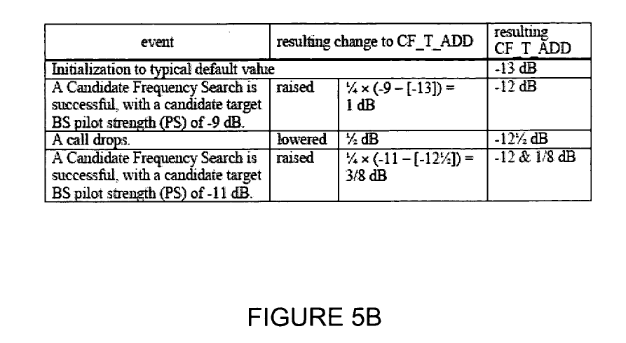

FIG. 5A illustrates a state diagram for dynamically adjusting the handoff thresholds in an inter-frequency hard handoff according to embodiments of the present disclosure. The embodiment of inter-frequency handoff diagram 500 shown in FIG. 5A is for illustration only. Other embodiments of the inter-frequency handoff diagram 500 could be used without departing from the scope of this disclosure.

In step 505, MS 113 starts a call (e.g., becomes engaged in a call). FBS 160 receives uplink messages from MS 113. Further, FBS 160 transmits downlink messages to MS 113. When the call is initiated, FBS 160 transmits the CFSRQM to MS 113. In the call started state (step 505), MS 113 receives the CFSRQM but the CFSRPM has not been transmitted by MS 113 and/or received by FBS 160. MS 113 monitors the pilot signal strength from FBS 160. MS 113 compares the pilot signal strength from FBS 160 against SF_TOTAL_Ec/Io to determine if the SF_TOTAL_Ec/Io threshold has been met. If the pilot signal strength from FBS 160 falls below SF_TOTAL_Ec/Io, then MS 113 initiates the CFS.

If the call is dropped prior to FBS 160 receiving the CFSRPM, which means that SF_TOTAL_Ec/Io has not been met, FBS 160 raises SF_TOTAL_Ec/Io in step 510. FBS 160 raises the SF_TOTAL_Ec/Io to cause MS 113 to start future candidate frequency searches before the base station Ec/Io has fallen off too much. Thus, FBS 160 raises SF_TOTAL_Ec/Io to increase the likelihood that a successful handoff will occur prior to the call being dropped.

FBS 160 receives the CFSRPM from MS 113 in steps 515 and/or 520. For example, MS 113 determines that the pilot signal from FBS 160 has dropped below SF_TOTAL_Ec/Io and conducts its first CFS and transmits its first CFSRPM. The CFSRPM includes only those pilot signal strengths above CF_T_ADD. For example, if the MS 113 determines that no pilot signal strengths are above CF_T_ADD, then the CFSRPM does not include pilots. The first CFSRPM received may include no PNs identified whose signal is greater than CF_T_ADD (in step 515). If FBS 160 receives a CFSRPM with no pilots in step 515, FBS 160 does not initiate a handoff. Therefore, MS 113 conducts additional CFS's and transmits new CFSRPMs periodically. In the event that the call drops prior to FBS 160 receiving a CFSRPM with at least one pilot greater than CF_T_ADD (in step 520), then MS 113 lowers CF_T_ADD in step 525. FBS 160 lowers CF_T_ADD to increase the likelihood that MS 113 will transmit a CFSRPM with PNs whose pilots are greater than CF_T_ADD as a result of CFS's associated with future calls. Thus, lowering CF_T_ADD increases the likelihood that a target base station will be identified, a handoff process initiated and a successful handoff will occur. The step size by which CF_T_ADD is lowered can be a parameter DELTA_DOWN. Further, the CF_T_ADD can be subject to a minimum value defined by another parameter, CF_T_ADD_Min. For example, CF_T_ADD can be initially set to negative thirteen decibels (−13 dB), DELTA_DOWN can be set to ½ dB and CF_T_ADD_Min can be set to −15 dB. When the call is dropped, FBS 160 lowers CF_T_ADD by DELTA_DOWN to −13½ dB. FBS 160 can continue to lower CF_T_ADD as needed until the CF_T_ADD is set to −15 dB. FBS 160 will not lower CF_T_ADD below the CF_T_ADD_Min value of −15 dB.

In step 520, FBS 160 receives a CFSRPM with at least one pilot greater than CF_T_ADD. The CFSRPM received in step 520 may have been the first CFSRPM transmitted by MS 113 or the CFSRPM received in step 520 may have been a subsequent CFSRPM transmitted after the first CFSRPM with no pilots (received in step 515). For example, in the event that MS 113 identifies one or more pilot signal strengths above CF_T_ADD, then the CFSRPM includes those one or more pilot signal strengths and the corresponding PNs.

When the CFSRPM indicates one or more pilot signal strengths above the threshold, FBS 160 initiates the handoff process and sends the HDM to MS 113 in step 530. If FBS 160 receives a layer 2 Ack from MS 113, in step 535 FBS 160 lowers SF_TOTAL_Ec/Io and raises CF_T_ADD. FBS 160 adjusts these threshold parameters (i.e., SF_TOTAL_Ec/Io and CF_T_ADD) to delay the occurrence of future handoffs (with their inherent risk of failure) as long as possible without having calls drop. Specifically, FBS 160 adjusts the threshold parameters to postpone when the pilot signal strength from FBS 160 falls below SF_TOTAL_Ec/Io and postpone when MS 113 identifies PN's whose signal is greater than CF_T_ADD. Postponing the future handoff until the target base station's signal strength is higher also improves the chance that the next handoff will be successful. FBS 160 raises CF_T_ADD by a DELTA_UP (discussed in further detail herein below with respect to Equation 1) value subject to a CF_T_ADD_Max value (e.g., a maximum value to which CF_T_ADD can be set). FBS 160 obtains a new CF_T_ADD value (e.g., raising CF_T_ADD) by using Equation 1:

CF_{—}T_ADD_{NEW}=CF_{—}T_ADD−DELTA_UP×(PS−CF_{—}T_ADD). [EQN. 1]

In Equation 1, PS denotes pilot strength.

For example, as illustrated in FIG. 5B, CF_T_ADD can be initially set to −13 dB, DELTA_UP can be set to ¼ dB and CF_T_ADD_Max can be set to −10 dB. The CFSRPM contains a candidate target base station with a pilot signal strength of negative nine decibels (PS=−9 dB). FBS 160 computes the new value for CF_T_ADD (e.g., CF_T_ADD_{NEW}) using Equation 1. Equation 1, with the present example values inserted, is:

CF_{—}T_ADD_{NEW}=(−13 dB)−¼×(−9 dB−(−13 dB)). [EQN. 1]

Therefore, CF_T_ADD_{NEW}=−12 dB.

After FBS 160 computes CF_T_ADD_{NEW}, FBS 160 sets CF_T_ADD to the computed value (e.g., sets CF_T_ADD to −12 dB). FBS 160 can continue to raise CF_T_ADD as long as candidate base stations with pilot signals strengths above the threshold (e.g., PS>CF_T_ADD) are identified or until the CF_T_ADD is set to −10 dB. FBS 160 will not raise CF_T_ADD above the CF_T_ADD_Max value of −10 dB. Thereafter, if the call is dropped, FBS 160 lowers CF_T_ADD by DELTA_DOWN (½ dB) to −12½ dB. FBS 160 can continue to lower CF_T_ADD as needed until CF_T ADD is set to −15 dB. FBS 160 will not lower CF_T_ADD below the CF_T_ADD_Min value of −15 dB.

If FBS 160 does not receive the layer 2 Ack from MS 113, in step 540 FBS 160 raises SF_TOTAL_Ec/Io (i.e., raises the serving pilot strength threshold) and lowers CF_T_ADD (i.e., target pilot threshold). The serving pilot strength threshold is raised in order to attempt future handoffs sooner before the base station Ec/Io has fallen off so much that the MS 113 is unable to receive the HDM. The target pilot threshold is lowered in order to identify target base stations to which to handoff a call sooner in order to attempt future handoffs sooner, before the base station Ec/Io has fallen off so much that the MS 113 is unable to receive the HDM.

In some embodiments, when a Candidate Frequency Search is successful, FBS 160 raises CF_T_ADD using Equation 2:

CF_{—}T_ADD_{NEW}=CF_{—}T_ADD+DELTA_UP. [EQN. 2]

In some embodiments, when a Candidate Frequency Search is successful, FBS 160 raises CF_T_ADD using Equation 3:

CF_{—}T_ADD_{NEW}=CF_{—}T_ADD+DELTA_UP×((minimum of PS and CF_{—}T_ADD_MAX)−CF_{—}T_ADD). [EQN. 3]

In some embodiments, the dynamic adjusting of CF_T_ADD is performed using fixed-point integer arithmetic. Values are scaled by 256 (i.e., the units are 1/256 dB). When applying to CF_T_ADD, the values are converted to the nearest ½ dB unit by rounding to the nearest ½ dB.

In some embodiments, FBS 160 adjusts CF_T_ADD using native units of ½ dB. For example, when a number “D” calls in a row drop without a Candidate Frequency Search yielding a candidate target base station whose pilot strength is higher than the current value of CF_T_ADD, the FBS 160 lowers CF_T_ADD by ½ dB, subject to the minimum value of CF_T_ADD_MIN. Further, when a number “H” HDMs in a row get acknowledged, FBS 160 raises CF_T_ADD, subject to CF_T_ADD_MAX, using Equation 4:

CF_{—}T_ADD_{NEW}=CF_{—}T_ADD+(PSₘᵢₙ−CF_{—}T_ADD)/QdB. [EQN. 4]

where PSₘᵢₙ is defined as the lowest of the pilot signals and CF_T_ADD_{NEW} is rounded to the nearest ½ dB.

Accordingly, FBS 160 continually adjusts SF_TOTAL_Ec/Io and CF_T_ADD at terminations of calls in an attempt to improve handoff timing. FBS 160 will raise or lower the threshold values in response to a call event (i.e., a call drops, the Handoff Direction Message is acknowledged, or the Handoff Direction Message is not acknowledged; alternatively, a number of calls in a row drop, a number of Handoff Direction Messages in a row get acknowledged, or a number of Handoff Direction Messages in a row do not get acknowledged). FBS 160 will transmit the new values for SF_TOTAL_Ec/Io and CF_T_ADD in a CFSRQM sent at the initiation of a subsequent call.

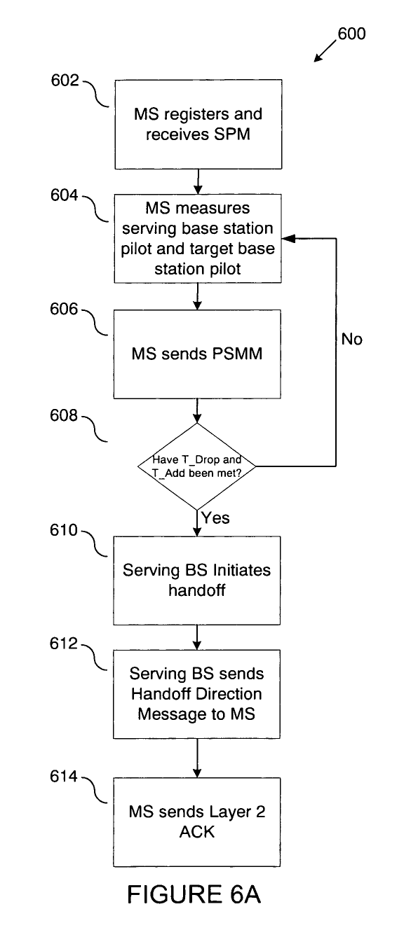

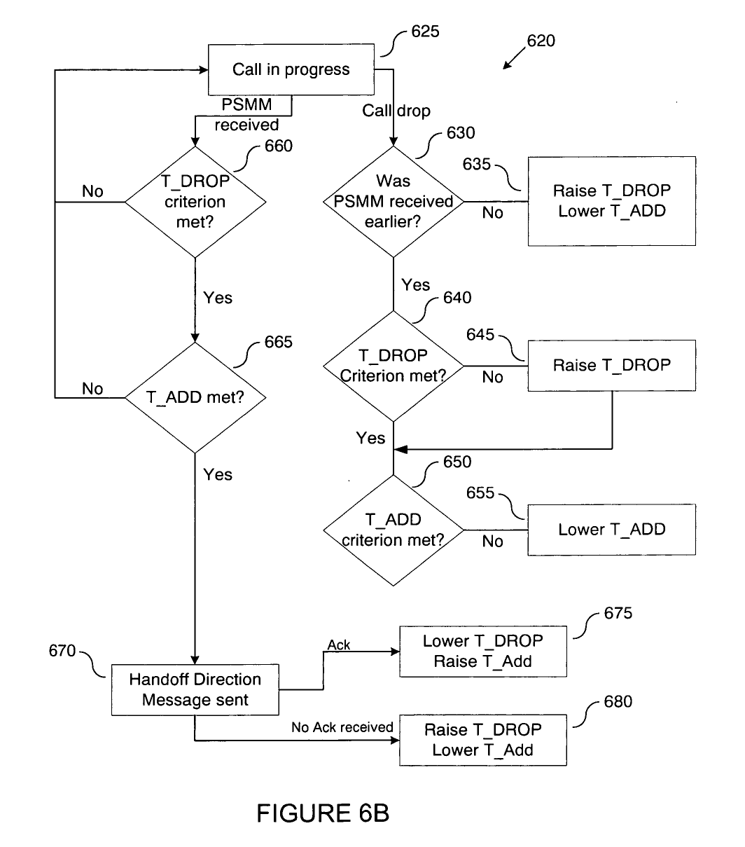

FIG. 6A illustrates a process for performing an intra-frequency hard handoff according to embodiments of the present disclosure. The embodiment of the intra-frequency handoff 600 shown in FIG. 6A is for illustration only. Other embodiments could be used without departing from the scope of this disclosure.

In step 602, MS 113 registers and receives a System Parameter Message (SPM). The SPM includes handoff threshold parameters: T_ADD and T_DROP. At the start of a call, MS 113 receives a neighbor list message that includes a list of target base stations PNs. MS 113 measures the pilot signal strength for FBS 160 (e.g., the serving BS) and target (e.g., BS 102) pilot signal strengths in step 604. MS 113 compares the serving pilot signal strength to T_DROP and the target base station pilot signal strength to T_ADD. In the event that MS 113 determines that either threshold has been met (e.g., serving pilot signal strength is less than T_DROP and/or at least one target pilot signal strength is greater than T_ADD), MS 113 sends a Pilot Signal Measurement Message (PSMM) to FBS 160 in step 606. FBS 160 determines if T_DROP and T_ADD have been met in step 608. In the event that only one of the handoff threshold parameters have been met (e.g., only one of T_DROP and T_ADD were met in the PSMM), then the process returns to step 604. MS 113 measures the pilot signals for FBS 160 and the target base stations periodically. In the event that both handoff threshold parameters have been met, then FBS 160 initiates a handoff in step 610. FBS 160 sends a handoff message via the IS-41 connection to BS 102. Additionally, FBS 160 transmits the HDM to MS 113. In step 614, MS 113 sends a layer 2 Ack to indicate a successful handoff operation.

FIG. 6B illustrates a state diagram for dynamically adjusting the handoff thresholds in an intra-frequency hard handoff according to embodiments of the present disclosure. The embodiment of intra-frequency handoff state diagram 620 shown in FIG. 6B is for illustration only. Other embodiments of the intra-frequency handoff state diagram 620 could be used without departing from the scope of this disclosure.

In step 625, MS 113 is engaged in a call. FBS 160 receives uplink messages from MS 113. Further, FBS 160 transmits downlink messages to MS 113. As stated herein above, with respect to FIG. 6A, MS 113 receives the SPM and the neighbor list message.

Also as stated herein above with respect to FIG. 6A, MS 113 transmits the pilot signal strengths to FBS 160 in the PSMM. MS 113 transmits the PSMM upon the occurrence of a triggering event, such as, but not limited to, when a signal strength for a target base station exceeds T_ADD, when a serving signal strength falls below a T_DROP, or both. The PSMM contains a list of candidate target base stations and the corresponding pilot signal strength measurements.

In the event that the call is dropped, in step 630 FBS 160 determines whether a PSMM previously was received from MS 113. If a PSMM was received prior to the call dropping, FBS 160 determines if the T_DROP criterion (e.g., source pilot signal strength lower than T_DROP) was met in step 640. The PSMM includes an indication that the MS 113 determined that the serving signal strength from the FBS 160 fell below T_DROP. If the T_DROP criterion was not met, FBS 160 raises T_DROP in step 645. T_DROP is raised to have, in the future, a handoff attempted sooner (e.g., before calls drop).

Whether or not the T_DROP criterion was met in the last PSMM, in step 650 FBS 160 determines if a candidate target base station with a pilot signal strength higher than T_ADD was reported in the last PSMM. In the event that the T_ADD criterion was not met, FBS 160 lowers T_ADD. T_ADD is lowered to have, in the future, at least one target base station for handoff identified sooner in a PSMM, before the call drops.

If no PSMM has been received before the call is dropped, that means that neither the T_DROP nor T_ADD criterion was met. So FBS 160 raises T_DROP and lowers T_ADD in step 635. T_ADD is lowered to identify at least one target base station for handoff in order to improve the likelihood that a handoff is attempted before the call drops. T_DROP is raised to have, in the future, a handoff attempted sooner, before the call drops.

In step 660, the PSMM is received by FBS 160 and the call is still in progress (e.g., the call has not been dropped). FBS 160 determines if the T_DROP criterion (e.g., serving pilot signal strength lower than T_DROP) has been met. If the T_DROP criterion is met, FBS 160 moves to step 665 to determine if T_ADD was met as well.

In step 665, FBS 160 determines if a candidate target base station with a pilot signal strength higher than T_ADD was reported in the PSMM. In the event that both the T_ADD and T_DROP criterion have not been met, then FBS 160 does not initiate a handoff and the call continues in step 625.

When both the T_ADD and T_DROP criterion have been met, FBS 160 transmits the HDM to MS 113 in step 670. FBS 160 initiates a handoff by sending a handoff message via a backhaul connection (e.g., IS-41) to BS 102 and an HDM to MS 113. If FBS 160 receives a layer 2 Ack from MS 113, then FBS 160 adjusts the handoff threshold parameters in step 675 as follows, it lowers T_DROP and raises T_ADD. FBS 160 adjusts T_DROP and T_ADD in step 675 in order to delay the occurrence of future handoffs (and the inherent risk associated with each handoff) for as long as possible without having calls drop. Specifically, FBS 160 adjusts the threshold parameters, T_DROP and T_ADD, to postpone when the serving signal drops below the T_DROP threshold and postpone when MS 113 identifies PNs whose signal is greater than T_ADD. Postponing future handoffs until the target base station's signal strength is higher also improves the chance that the next handoff will be successful.

If FBS 160 does not receive the layer 2 Ack from MS 113, FBS 160 raises T_DROP (i.e., the serving pilot strength threshold) and lowers T_ADD (i.e., target pilot threshold) in step 680. The serving pilot strength threshold (T_DROP) is raised in order to attempt future handoffs sooner, before the base station Ec/Io has fallen off so much that MS 113 is unable to receive the HDM. T_ADD is lowered in order to identify target base stations to which to handoff a call sooner, in order to attempt future handoffs sooner, before the base station Ec/IO falls off so much that MS 113 is unable to receive the HDM.

Accordingly, FBS 160 continually adjusts T_DROP and T_ADD at the termination of calls in an attempt to improve handoff timing. FBS 160 will raise or lower the threshold values in response to a call event (i.e., a call drops, the Handoff Direction Message is acknowledged, or the Handoff Direction Message is not acknowledged; alternatively, a number of calls in a row drop, a number of Handoff Direction Messages in a row get acknowledged, or a number of Handoff Direction Messages in a row do not get acknowledged).

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of operating a base station, the method comprising:
transmitting a first message to a mobile station, the first message including a first threshold for use in measuring against a serving frequency strength and a second threshold for determining one or more target base stations; and
dynamically adjusting a value of at least one of the first threshold parameter and second threshold parameter in response to a call event.

2. The method as set forth in claim 1, wherein determining the call event is one of: a call drops, a Handoff Direction Message is acknowledged, the Handoff Direction Message is not acknowledged, a number of calls in a row drop, a number of Handoff Direction Messages in a row get acknowledged and a number of Handoff Direction Messages in a row do not get acknowledged.

3. The method as set forth in claim 1, wherein the handoff is one of an inter-frequency handoff or an intra-frequency handoff.

4. The method as set forth in claim 1, wherein dynamically adjusting comprises dynamically adjusting one of the first threshold or the second threshold.

5. The method as set forth in claim 1, wherein dynamically adjusting comprises dynamically adjusting the first and the second threshold.

6. The method as set forth in claim 1, wherein the call event is a dropped call and wherein dynamically adjusting further comprises raising the first threshold in response to the dropped call.

7. The method as set forth in claim 1, wherein the call event is a response to the handoff direction message and wherein dynamically adjusting further comprises lowering the first threshold and raising the second threshold in response to an acknowledgment received from the mobile station and raising the first threshold and lowering the second threshold in response to not receiving the acknowledgement from the mobile station.

8. The method as set forth in claim 1, wherein the call event is a dropped call and wherein dynamically adjusting further comprises at least one of:
prior to receiving a second message raising the first threshold; and
after receiving a second message with no pilots lowering the second threshold.

9. The method as set forth in claim 8, wherein the call event is a dropped call prior to receiving a second message and wherein dynamically adjusting further comprises raising the first threshold and lowering the second threshold.

10. The method as set forth in claim 1, wherein the call event is a dropped call after receiving a second message and wherein dynamically adjusting further comprises at least one of:
raising the first threshold if the first threshold was not met; and
lowering the second threshold if the second threshold was not met.

11. A wireless communication network, the wireless communication network comprising:
a plurality of base stations, each one of the plurality of base stations capable of performing a handoff process, wherein at least one of the plurality of base stations comprising a handoff controller configured to cause the base station to:
transmit a first message to a mobile station, the first message including a first threshold for use in measuring against a serving frequency strength and a second threshold for determining one or more target base stations; and
dynamically adjust a value of at least one of the first threshold parameter and second threshold parameter in response to a call event.

12. The wireless communication network as set forth in claim 11, wherein determining the call event is one of: a call drops, a Handoff Direction Message is acknowledged, the Handoff Direction Message is not acknowledged, a number of calls in a row drop, a number of Handoff Direction Messages in a row get acknowledged and a number of Handoff Direction Messages in a row do not get acknowledged.

13. The wireless communication network as set forth in claim 10, wherein the handoff process is one of an inter-frequency handoff and an intra-frequency handoff.

14. The wireless communication network as set forth in claim 11, wherein the base station dynamically adjusts one of the first threshold or the second threshold.

15. The wireless communication network as set forth in claim 11, wherein the base station dynamically adjusts the first threshold and the second threshold.

16. The wireless communication network as set forth in claim 11, wherein the base station controller is configured to raises a value of the first threshold in response to the dropped call.

17. The wireless communication network as set forth in claim 11, wherein the call event is a response to the handoff direction message and wherein the base station controller is configured to lower the first threshold and raise the second threshold in response to an acknowledgement received from the mobile station and raise the first threshold and lower the second threshold in response if the acknowledgement is not received.

18. The wireless communication network as set forth in claim 11, wherein the call event is a dropped call and wherein the base station controller is configured to at least one of:
prior to receiving a second message, raise the first threshold; and
after receiving a second message with no pilots, lower the second threshold.

19. The wireless communication network as set forth in claim 11, wherein the call event is a dropped call prior to receiving a second message and wherein the base station controller is configured to raise the first threshold and lower the second threshold.

20. The wireless communication network as set forth in claim 11, wherein the call event is a dropped call after receiving a second message and wherein the base station controller is configured to at least one of:
raising the first threshold if the first threshold was not met; and
lowering the second threshold if the second threshold was not met.

21. For use in a wireless communication network, a base station capable of performing handoffs, the base station comprising:
a base station controller;
a transceiver; and
a handoff controller, the handoff controller configured to cause the base station to:
transmit a first message to a subscriber station, the first message including a first threshold for use in measuring against a serving frequency strength and a second threshold for determining one or more target base stations; and
dynamically adjust a value of at least one of the first threshold parameter and second threshold parameter in response to a call event.

22. The base station as set forth in claim 21, wherein the call event comprises at least one of: a call drops, a Handoff Direction Message is acknowledged, the Handoff Direction Message is not acknowledged, a number of calls in a row drop, a number of Handoff Direction Messages in a row get acknowledged and a number of Handoff Direction Messages in a row do not get acknowledged.

23. The base station as set forth in claim 21, wherein the base station is one of a femto base station and a macro base station.

24. The base station as set forth in claim 21, wherein the handoff controller further is configured to dynamically adjust one of the first threshold or the second threshold.

25. The base station as set forth in claim 21, wherein the handoff controller further is configured to dynamically adjust one of the first threshold or the second threshold.

26. The base station as set forth in claim 21, wherein the handoff controller is configured to raises a value of the first threshold in response to the dropped call.

27. The base station as set forth in claim 21, wherein the call event is a response to the handoff direction message and wherein the handoff controller is configured to lower the first threshold and raise the second threshold in response to an acknowledgement received from the mobile station and raise the first threshold and lower the second threshold in response if the acknowledgement is not received.

28. The base station as set forth in claim 21, wherein the call event is a dropped call and wherein the handoff controller is configured to at least one of:
prior to receiving a second message, raise the first threshold; and
after receiving a second message with no pilots, lower the second threshold.

29. The base station as set forth in claim 21, wherein the call event is a dropped call prior to receiving a second message and wherein the handoff controller is configured to raise the first threshold and lower the second threshold.

30. The wireless communication network as set forth in claim 21, wherein the call event is a dropped call after receiving a second message and wherein the handoff controller is configured to at least one of:
raising the first threshold if the first threshold was not met; and
lowering the second threshold if the second threshold was not met.

31. The base station as set forth in claim 21, wherein the handoff controller further is configured to transmit a new set of threshold values upon the initiation of a subsequent call.
